(19) United States
(12) Patent Application Publication
(10) Pub. No.: US 2022/0342535 A1
(43) Pub. Date: Oct. 27, 2022

(54) DEVICE AND METHOD FOR DISPLAYING CHART

(71) Applicant: Furuno Electric Co., Ltd., Nishinomiya-City (JP)

(72) Inventor: Jun YAMABAYASHI, Osaka-Sayama (JP)

(73) Assignee: Furuno Electric Co., Ltd., Nishinomiya-City (JP)

(21) Appl. No.: 17/851,177

(22) Filed: Jun. 28, 2022

Related U.S. Application Data
(63) Continuation of application No. PCT/JP2021/000306, filed on Jan. 7, 2021.

(30) Foreign Application Priority Data
Feb. 12, 2020 (JP) 2020-021622

(51) Int. Cl. G06F 3/04845; G06F 3/04883

(52) U.S. Cl. CPC G06F 3/04845; G06F 3/04883

(57) ABSTRACT

Provided is a chart display device for partially confirming a chart. In an example, the chart display device includes a display configured to display the chart on a screen, and detect a touched position of the screen. The chart display device includes processing circuitry configured to determine whether an operation auxiliary tool having detected elements to be detected based on the touched position is placed on the screen, specify a corresponding area corresponding to the operation auxiliary tool in the chart based on the position of the detected elements, and receive an operation for the corresponding area in the chart.

### CROSS-REFERENCE TO RELATED APPLICATION(S)

This application is a continuation of PCT International Application No. PCT/JP2021/000306, which was filed on Jan. 7, 2021, and which claims priority to Japanese patent Application No. 2020-021622 filed on Feb. 12, 2020, the entire disclosures of each of which are herein incorporated by reference for all purposes.

### TECHNICAL FIELD

The present disclosure relates generally to display devices, and specifically to display devices and display methods for displaying navigational charts, and program for displaying navigational charts.

### BACKGROUND

In naval navigation systems, a navigational chart system is used to display a navigational chart. The navigational chart may be used to pinpoint locations and attain directions. In an example, a display associated with the navigational chart system may be configured as a touch panel. Subsequently, based on touch inputs on the touch panel, various processes may be performed on the navigational charts. In some cases, the navigational chart may be seen by multiple people from multiple corresponding locations. To this end, the multiple people may not be able to see a same location and corresponding information on the navigational chart accurately owing to different field of view of the multiple people from the multiple corresponding locations.

Patent Document 1 discloses a chart display device. As used herein, the patent document 1 may be WO 2019/093456. As per the patent document 1, the chart display device describes a measuring tool, such as a ruler, being placed on a screen or a display that is displaying a chart. The patent document 1 describes displaying a distance scale according to a scale of the chart at a position where the measuring tool is placed on the screen based on the position and the direction of the measuring tool.

However, in the patent document 1, the distance scale is displayed in the ruler according to the scale of the chart. Therefore, the patent document 1 does not provide any means for displaying accurate and consistent view of a particular location on the chart to multiple people. As a result, when a large number of people may be viewing the chart, the people may be unable to view a particular location, specifically, image corresponding to the particular location, on the chart in an accurate manner.

In view of the above problem, it is an object of the present disclosure to provide a display device, a display method, and a computer-program capable of accurately displaying location in a navigational chart.

### SUMMARY

A first aspect of the present disclosure relates to a chart display device. The chart display device includes a display configured to display a chart on a screen, and detect a touched position of the screen. Further, the chart display device includes processing circuitry configured to determine whether an operation auxiliary tool having detected elements is placed on the screen, the detected elements being detected based on the touched position on the screen. The processing circuitry is configured to specify a corresponding area corresponding to the operation auxiliary tool in the chart, based on a position of the detected elements of the operation auxiliary tool placed on the screen. The processing circuitry is further configured to receive an operation for the corresponding area in the chart.

According to the chart display device of the present embodiment, since a corresponding area corresponding to a touched position on the chart may be accurately identified and a user-defined operation may be performed on the corresponding area, such corresponding area may be suitably confirmed or highlighted. For example, the operation to be performed may correspond to enlargement of the corresponding area, a reduction of the corresponding area, such as enlargement or reduction in size, etc. to enhance visibility of or highlighting the corresponding area. This may enable multiple users to see the chart, specifically the corresponding area, accurately from different angles. Accordingly, it may become easy to partially confirm the corresponding area in the chart by multiple users.

The processing circuitry of the chart display device according to the present embodiment may further be configured to receive an operation associated with a predetermined pattern when a change pattern of the position of the detected elements coincides with the predetermined pattern. This enables performing specific predetermined operation based on the predetermined pattern on the corresponding area.

According to an embodiment, the change pattern is inputted when the operation auxiliary tool placed on the screen is rotated or translated.

According to another embodiment of the present disclosure, a chart display method for a chart display device is provided. The chart display device includes a display configured to display a chart on a screen and detect a touched position of the screen. The chart display method includes determining whether an operation auxiliary tool having detected elements is placed on the screen, the detected elements being detected based on the touched position on the screen. The chart display method includes specifying a corresponding area corresponding to the operation auxiliary tool in the chart based on the position of the detected elements of the operation auxiliary tool placed on the screen. The chart display method includes receiving an operation on the corresponding area in the chart.

According to another embodiment of the present disclosure, an operation auxiliary tool according is provided. The operation auxiliary tool used in a chart display device having a display configured to display a chart on a screen and detect a touched position of the screen, the operation auxiliary tool comprising; detected elements configured to be detected, the detected elements being detected by the display; and inputting an operation for a corresponding area in the chart corresponding to the operation auxiliary tool being specified based on the position of the detected elements of the operation auxiliary tool placed on the screen.

According to the present disclosure, it is easy to partially confirm the chart.

### BRIEF DESCRIPTION OF DRAWINGS

The embodiments of the present disclosure is illustrated by way of example and not by way of limitation in the figures of the accompanying drawings, in which the like reference numerals indicate like elements and in which:

FIG. 1 is a block diagram of an example ship ICT system, in accordance with an embodiment;

FIG. 2 is a diagram an example chart display device, in accordance with an embodiment;

FIG. 3 is a diagram of an example configuration of an operation auxiliary tool, in accordance with an embodiment;

FIG. 4 is a block diagram of an example configuration of a chart display device, in accordance with an embodiment;

FIG. 5 is a diagram showing an example process of a chart display method, in accordance with an embodiment;

FIGS. 6A, 6B and 6C are diagrams showing an example operation for enlarging and reducing a size of a corresponding area, in accordance with an embodiment;

FIG. 7 is a diagram showing an example operation for changing a direction of a corresponding area, in accordance with another embodiment;

FIGS. 8A and 8B are diagrams showing an example operation for moving a copy of a corresponding area to another position, in accordance with yet another embodiment;

FIG. 9 is a diagram showing an example operation for replacing a corresponding area with an image, in accordance with another embodiment;

FIG. 10 is a diagram showing an example operation for displaying information associated with a corresponding area, in accordance with yet another embodiment; and

FIGS. 11A, 11B and 11C are diagrams showing an example operation for blinking a corresponding area in a blinking pattern, in accordance with an embodiment.

### DETAILED DESCRIPTION

Embodiments of the present disclosure will be described below with reference to the drawings.

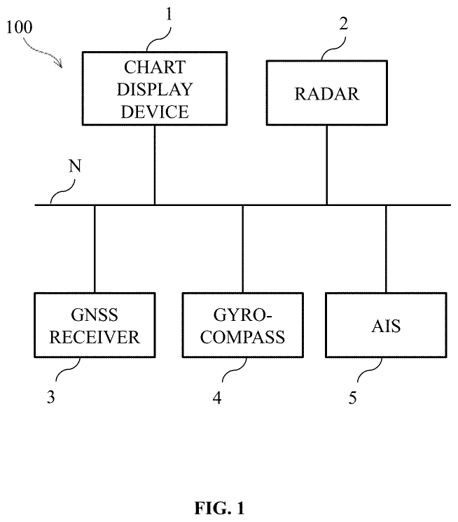

FIG. 1 is a block diagram of an example of a ship ICT system 100 including a chart display device 1, according to an embodiment.

The ship ICT system 100 includes, for example, a radar 2, a GNSS receiver 3, a gyrocompass 4, and an AIS 5 in addition to the chart display device 1. These apparatuses are connected to a network N such as a LAN (Local Area Network), for example, and may perform network communication with each other.

In an example, the chart display device 1 is an ECDIS (Electronic Chart Display and Information System). The chart display device 1 may be a GNSS plotter. A specific configuration example of the chart display device 1 will be described later.

In some embodiments, the chart display device 1 may be configured as a device capable of cooperating with the ECDIS and may be different from the ECDIS.

Further, the radar 2 detects a target existing around corresponding or own ship associated with the ship ICT system 100 and generates target tracking data (TT data) representing a position and a velocity vector of the target.

The GNSS receiver 3 detects a position of the corresponding ship associated with the ship ICT system 100, based on radio waves received from GNSS (Global Navigation Satellite System), and generates position data representing the position of the corresponding ship.

The gyrocompass 4 detects a heading of the corresponding ship and generates bearing data showing the heading. Alternatively, a GPS compass or a magnetic compass may be used.

The AIS (Automatic Identification System) 5 transmits AIS data to surrounding ships and land control, and receives AIS data from surrounding ships and land control. In addition, a VDES (VHF Data Exchange System) may be used in the ship ICT system 100.

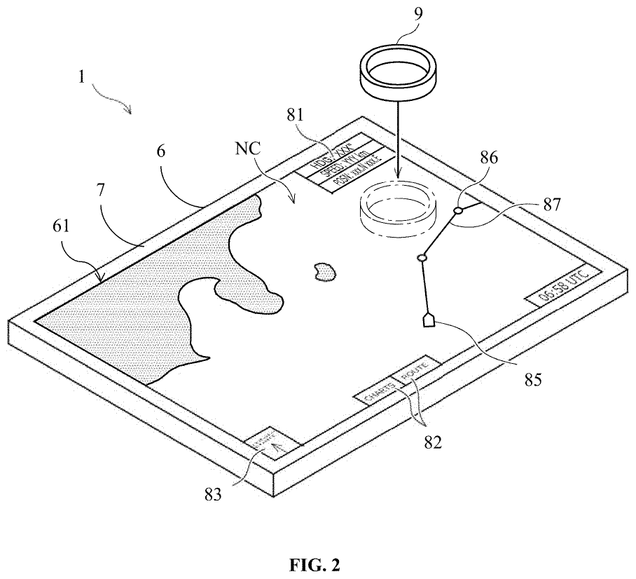

FIG. 2 illustrates a diagram of an example chart display device 1, in accordance with an embodiment.

As shown in FIG. 2, the chart display device 1 includes a display 6 for displaying a chart NC on a screen 204. The chart display device 1 or the display 6 includes a touch position detection module 7 for detecting a touched position of the screen 61. In an example, the touch position detection module 7 is disposed on the screen 61 of the display 6.

In the present embodiment, the display 6 is relatively large (For example, a screen size of 40 inches or larger), and the display 6 is arranged in such a manner that the screen 61 faces upward. For example, the display 6 has a table shape and may be surrounded by a plurality of persons. In addition, the display 6 may be arranged with the screen 61 oriented horizontally or obliquely upward.

The display 6 is, for example, a liquid crystal display (LCD) or an organic electric lift (EL) display. The touch position detection module 7 is, for example, a capacitive touch sensor, and may detect a touch position by a finger or a stylus pen. Further, the touch position detection module 7 may detect an operation auxiliary tool 9 placed on the screen 61.

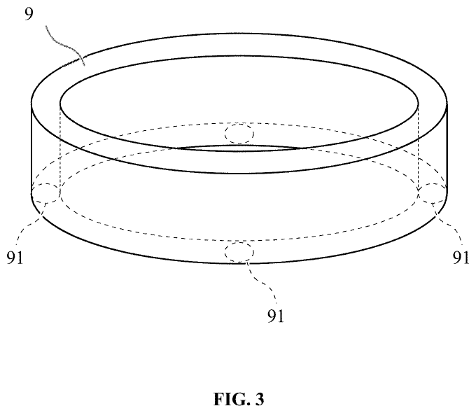

FIG. 3 illustrates a diagram of an example configuration of the operation auxiliary tool 9 used in the chart display device 1, in accordance with an embodiment. As shown in FIG. 3, the operation auxiliary tool 9 has a shape like a loupe, for example. Specifically, the operation auxiliary tool 9 has a thin cylindrical shape with a relatively short axial direction. The operation auxiliary tool 9 is placed on the screen 61 so that one end face of the operation auxiliary tool 9 faces the screen 61. In other words, the axial direction of the operation auxiliary tool 9 is aligned with a normal direction of the screen 61 (see FIG. 2).

In an example, body of the operation auxiliary tool 9 is formed of a non-conductive material which is not detectable by the touch position detection module 7. The body of the operation auxiliary tool 9 may or may not be transparent. The operation auxiliary tool 9 is not limited to a hollow cylindrical shape, but may be a solid cylindrical shape in which the inside is filled or the whole is formed of a transparent material.

In accordance with an embodiment, an end face of the operation auxiliary tool 9 may be provided with a plurality of detected elements 91 that may be detected by the touch position detection module 7. The plurality of detected elements 91 are arranged at predetermined intervals along an outer edge of the operation auxiliary tool 9. When the touch position detection module 7 is a capacitive touch sensor, the detected element 91 is formed of, for example, conductive rubber.

The detected elements 91 may be provided on both end faces of the operation auxiliary tool 9. Thus, the operation auxiliary tool 9 may be used even if it is inverted. In addition, it is not limited to the plurality of detected elements 91. For example, one detected element from the plurality of detected elements 91 may have a predetermined area. Such predetermined area may be provided on an end face of the operation auxiliary tool 9.

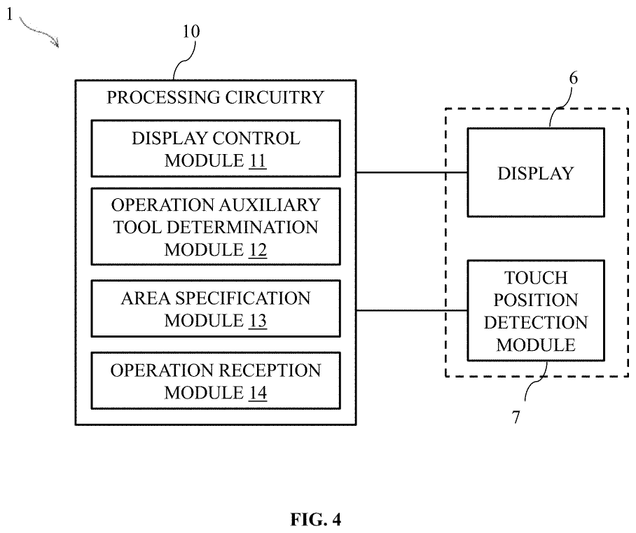

FIG. 4 illustrates a block diagram of an example configuration of the chart display device 1, in accordance with an embodiment. As shown in FIG. 4, the chart display device 1 includes processing circuitry 10 (also referred to as a control module) to which the display 6 and the touch position detection module 7 are connected.

In an example, the processing circuitry 10 is a computer including a CPU, a RAM, a ROM, a nonvolatile memory, an input/output interface, and the like. For example, the CPU of the processing circuitry 10 executes information processing according to a program loaded from a ROM or a nonvolatile memory into a RAM.

In accordance with an embodiment, the program may be supplied via an information storage medium such as, for example, an optical disk or a memory card, or may be supplied via a communication network such as, for example, the Internet or a LAN.

In an example, the nonvolatile memory of the processing circuitry 10 stores various data such as a program, chart data, data of a point registered by a user, data of a route created by the user, and the like. These data may be acquired from an external device via the network N.

The processing circuitry 10 includes a display control module 11, an operation auxiliary tool determination module 12, an area specification module 13, and an operation reception module 14. These functional modules are realized by the CPU or one or more processors of the processing circuitry 10 executing information processing in accordance with a program.

In an example, the display control module 11, the operation auxiliary tool determination module 12, the area specification module 13, and the operation reception module 14 may include suitable logic, circuitry, and interfaces that may be configured to perform operations associated with the processing circuitry 10 for displaying the chart NC and performing further operation on it. In another example, the processing circuitry 10 may perform the operations described below using one or more processors independently.

The display control module 11 may be configured to perform processing for displaying the chart NC, or the like, on the screen 61 of the display 6. The operation auxiliary tool determination module 12 may be configured to determine whether or not the operation auxiliary tool 9 is placed on the screen 61 of the display 6 based on a detection signal of the touch position detection module 7.

When it is determined that the operation auxiliary tool 9 is placed on the screen 61, the area specification module 13 may be configured to specify a corresponding area corresponding to the operation auxiliary tool 9 in the chart NC based on a position of the detected elements 91 of the operation auxiliary tool 9.

The operation reception module 14 may be configured to receive a prescribed operation for the corresponding area in the chart NC. The details of the processes performed by the display control module 11, the operation auxiliary tool determination module 12, the area specification module 13, and the operation reception module 14 will be described later.

Returning to FIG. 2, information relating to the corresponding ship associated with the ICT ship system 100 may be displayed on the screen 61 of the display 6. In an example, the displayed information may be superimposed on the chart NC. For example, the displayed information may include a corresponding ship basic information 81 showing the position and the heading of the corresponding ship in text, a menu button 82 for managing the chart NC, creating a route, etc., and adjustment button 83 for adjusting the orientation of the chart NC.

On the screen 61 of the display 6, a corresponding or own ship symbol 85 indicating the position and the heading of the corresponding ship with symbols on the chart NC, a waypoint 86 registered in advance by a user, and a route 87 set to follow the waypoint 86 in order are displayed.

The position and the orientation or heading of the own ship symbol 85 in the screen 61 are determined so as to correspond to a position data generated by the GNSS receiver 3, and an orientation or heading data generated by the gyrocompass 4. Further, another ship symbol indicating another ship may be displayed based on AIS data acquired by the AIS 5.

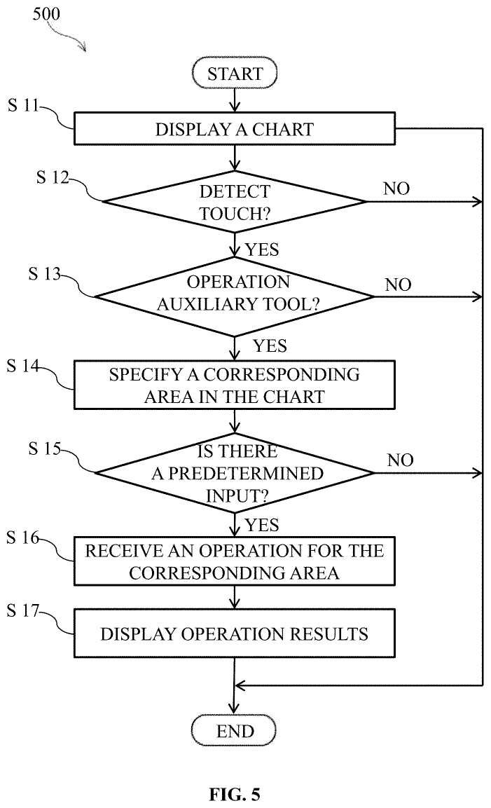

FIG. 5 is a diagram showing an example process of a chart display method, according to an embodiment. The chart display method 500 may be implemented in a chart display device, such as the chart display device 1. In an example, the processing circuitry 10 of the chart display device 1 is configured to execute information processing shown in the chart in accordance with a program.

At S 11, a chart is displayed. In an example, the processing circuitry 10 may be configured to display the chart NC or the like on the screen 61 of the display 6. The processing circuitry 10 may be configured to perform processing to display the chart NC using the display control module 11.

At S 12, the processing circuitry 10 may be configured to determine whether or not the screen 61 is touched based on a detection signal from the touch position detection module 7, i.e., based on the touched position on the screen.

When a touch input (also referred to hereinafter as “touch”) on the screen 61 is detected, at S 12, the method may move to S 13. At S 13, the processing circuitry 10 may be configured to determine whether the touch is by the operation auxiliary tool 9, or not. In particular, the processing circuitry 10 may be configured to determine whether the operation auxiliary tool 9 is placed on the screen 61, or not. The processing circuitry 10 may be configured to perform processing to make the determination using the operation auxiliary tool determination module 12.

Specifically, the determination of whether or not the operation auxiliary tool 9 is placed on the screen 61 is realized by determining whether or not a positional relationship of detected plurality of touch positions corresponds to a predetermined positional relationship. In other words, a pattern made by the detected plurality of touch positions is compared with the predetermined positional relationship. The predetermined positional relationship relates to positioning pattern of elements 91 of the operation auxiliary tool 9. If the detected plurality of touch positions matches with the predetermined positional relationship, the operation auxiliary tool 9 is determined to be placed on the screen 61. Further, it may be added to the condition that the positional relationship of the plurality of detected touch positions does not change for a predetermined period of time.

If it is determined that the operation auxiliary tool 9 is placed on the screen 61 at S 13, the method may move to S 14. At S 14, the processing circuitry 10 may be configured to specify a corresponding area in the chart NC corresponding to the operation auxiliary tool 9 based on the position of the detected elements 91 of the operation auxiliary tool 9. The processing circuitry 10 may be configured to perform processing to specify the corresponding area using the area specification module 13.

Specifically, in the chart NC displayed on the screen 61, an area having a predetermined shape determined by the positions of the plurality of detected elements 91 of the operation auxiliary tool 9 is specified as a corresponding area. For example, a circular area may be defined by the plurality of detected elements 91 of the cylindrical operation auxiliary tool 9. To this end, the plurality of detected elements 91 may be provided along an outer edge on a lower surface or end face of the cylindrical operation auxiliary tool 9. Subsequently, an area enclosed by the plurality of detected elements 91, i.e., an area encompassed by the lower surface of the cylindrical operation auxiliary tool 9 may be specified as a corresponding area.

At S 15, a determination is made regarding whether a predetermined input is received from a user. When a predetermined input is received from the user at S 15, the method may move to S 16. At S 16, the processing circuitry 10 may be configured to receive an operation for the corresponding area in the chart NC. Accordingly, the processing circuitry 10 may be configured to perform processing to receive the predetermined input and the operation using the operation receiving module 14.

Further, at S 17, the processing circuitry 10 may be configured to display an operation result on the screen 61 of the display 6. The processing circuitry 10 may be configured to perform processing to display the operation result using the display control module 11.

Specifically, the processing circuitry 10 may be configured to detect an input from the user based on the detection signal of the touch position detection module 7, and receive the operation for the corresponding area preliminarily associated with the input. The operation for the corresponding area preliminarily associated with the input is, for example, an operation for changing the corresponding area.

In an example, an input by the user may be an input by the operation auxiliary tool 9, such as by rotating or translating the operation auxiliary tool 9 on the screen 61. When a change pattern of the position of the detected elements 91 coincides with a predetermined pattern, the processing circuitry 10 may be configured to receive an operation preliminarily associated with the predetermined pattern.

In another example, an input by the user may be an input by a touch other than the operation auxiliary tool 9, such as drawing a predetermined locus with a finger, or the like. For example, the locus may be drawn while the operation auxiliary tool 9 is placed on the screen 61. When a change pattern of a touch position detected together with the detected elements 91 of the operation auxiliary tool 9 coincides with a predetermined pattern, the processing circuitry 10 may be configured to receive an operation preliminarily associated with the predetermined pattern or the predetermined locus.

A specific example of the user's input and operation of the corresponding area will be described below.

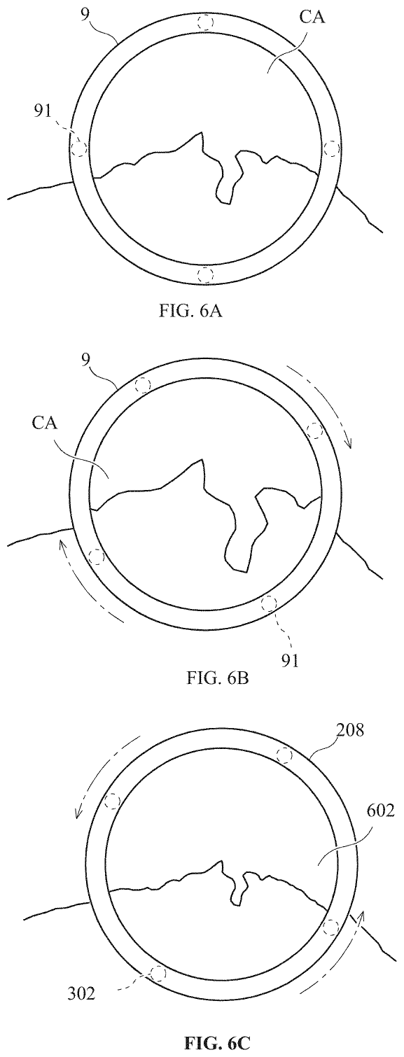

FIGS. 6A, 6B and 6C illustrate an example operation for enlarging and reducing a size of a corresponding area CA in the chart NC, in accordance with an embodiment. In an example, FIG. 6A shows the example of the corresponding area CA. For example, different operations may be performed on the corresponding area CA, based on an input received from a user. In an example, the input may be provided by the user, via the operation auxiliary tool 9, or any other type of touch input, on the screen 61 of the chart display device 1.

As shown in FIG. 6B when the user rotates the operation auxiliary tool 9 clockwise, the corresponding area CA may be enlarged and displayed. Moreover, as shown in FIG. 6C when the user rotates the operation auxiliary tool 9 counterclockwise, the corresponding area CA may be reduced and displayed. Thus, it is possible to confirm a part of the chart NC by enlarging or reducing it.

Specifically, when the processing circuitry 10 detects that the plurality of detected elements 91 have moved in a clockwise circular manner, it receives an operation for enlarging the corresponding area CA and displays the enlarged corresponding area CA. On the other hand, when the plurality of detected elements 91 move in a counterclockwise circular manner, the processing circuitry 10 receives an operation to reduce the corresponding area CA and displays the reduced corresponding area CA.

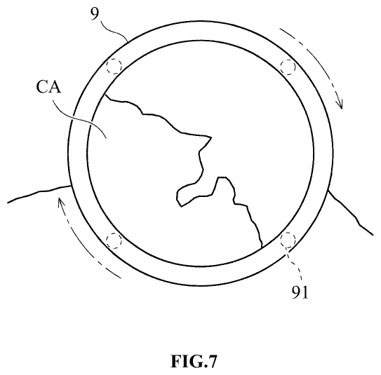

FIG. 7 illustrates an operation for changing a direction of the corresponding area CA in the chart NC, in accordance with another embodiment. In particular, the corresponding area CA is rotated. For example, when a user rotates the operation auxiliary tool 9 clockwise or counterclockwise, the corresponding area CA is displayed by changing its direction accordingly. Thus it is possible to confirm a part of the chart NC in a desired direction.

Specifically, when the processing circuitry 10 detects that the plurality of detected elements 91 have moved in a circular manner, it receives an operation to change the direction of the corresponding area CA. The processing circuitry 10 may then rotate the corresponding area CA to display it so that a positional relationship with the detected elements 91 is maintained. In order to distinguish from the aforementioned enlargement or reduction, input by touch of a finger or the like may be combined. In other words, to distinguish operation of enlargement or reduction of the corresponding area CA based on rotation of the operation auxiliary tool 9 (as described in FIGS. 6 (a)-6 (c)) and rotation of the direction of the corresponding area CA, certain additional touch input may be required for rotation operation to change the direction of the corresponding area CA. In an example, when the processing circuitry 10 detects mere rotation of the detected elements of the operation auxiliary tool 9, the operation corresponding to enlargement and/or reduction of the corresponding area CA may be performed. However, when the processing circuitry 10 detects a rotation of the detected elements of the operation auxiliary tool 9 along with a touch of a finger on the screen 61 and/or pressure on the operation auxiliary tool 9, the operation corresponding to rotation of the corresponding area CA to change its direction may be performed.

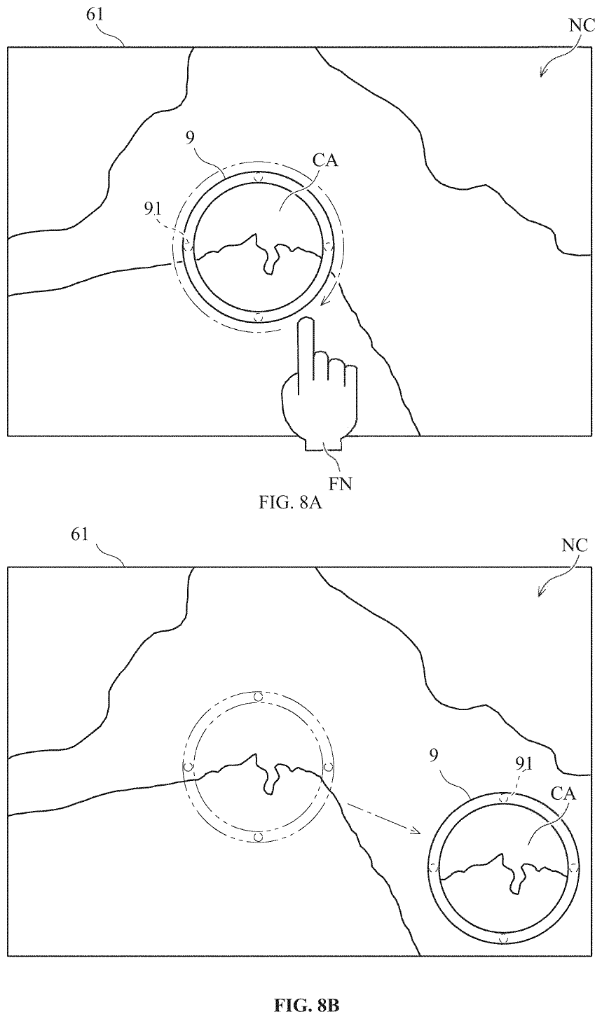

FIGS. 8A and 8B illustrate an operation for moving a copy of the corresponding area CA in the chart NC, in accordance with yet another embodiment. The operation may be an operation for moving the copy of the corresponding area CA to another position in the chart NC, in accordance with a movement of the operation auxiliary tool 9. To this end, the corresponding area CA is cut from the chart NC. As shown in FIG. 8A, when the user draws a circle around the operation auxiliary tool 9 with a finger FN, the corresponding area CA is cut from the chart NC. Further, as shown in FIG. 8B a copy of the corresponding area CA is moved and displayed together with the operation auxiliary tool 9 at another position in the chart NC.

Specifically, when the processing circuitry 10 detects that a touch of the finger FN or the like has moved in a circle surrounding the plurality of detected elements 91, the processing circuitry 10 generates a copy of the corresponding area, and moves and displays the copy of the corresponding area CA so that a positional relationship with the detected elements 91 is maintained. Thus, a part of the chart NC may be moved to a desired position. For example, a position close to an edge of the screen 61 to be confirmed or viewed.

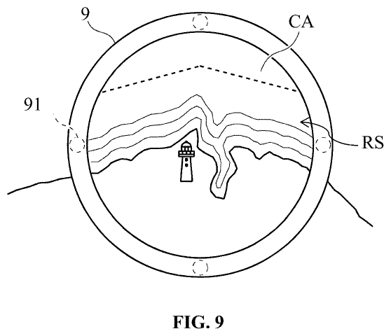

FIG. 9 illustrates an operation for replacing the corresponding area CA in the chart NC, in accordance with another embodiment. The operation may be an operation to replace the corresponding area CA with another image RS. For example, when a predetermined input is made by the operation auxiliary tool 9 or by a touch of a finger or the like, the image of the corresponding area CA in the chart NC of a vector format is replaced with another image RS of a raster format in a same area in the chart NC.

In addition, if the display 6 is a 3D display, the corresponding area CA may be replaced with an image for 3D display. In another embodiment, the corresponding area CA may be replaced with a radar image based on TT data acquired from the radar 2. Thus, a part of the chart NC may be confirmed by an image of a desired format or an image having desired information.

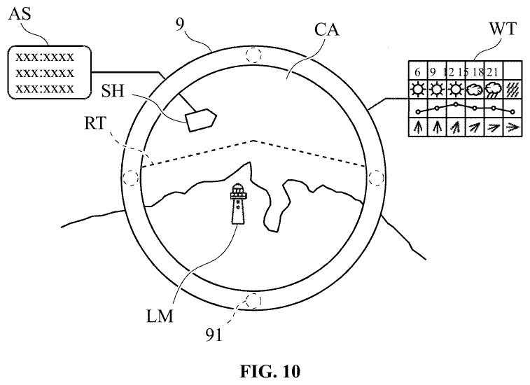

FIG. 10 illustrates an operation for displaying information associated with the corresponding area CA in the chart NC, in accordance with yet another embodiment. For example, when a predetermined input is made by the operation auxiliary tool 9 or by touching a finger or the like, information (such as meteorological and oceanographic information WT; past tracks RT; landmarks LM such as lighthouses on land; AIS information of other ships and corresponding symbols SH of other ships; etc.) associated with the corresponding area CA are additionally displayed.

The information associated with the corresponding area CA may be displayed inside the corresponding area CA. For example, as shown in FIG. 10, the past track RT and landmarks LM on land may be displayed inside the corresponding area CA. Alternatively, information associated with the corresponding area CA may be displayed outside the corresponding area CA. For example, as shown in FIG. 10, the meteorological/oceanographic information WT and AIS information AS may be displayed outside the corresponding area CA. The information may be displayed in a manner associated with the corresponding area CA or a symbol inside the corresponding area CA. Thus, desired information related to a part of the chart NC may be confirmed or viewed.

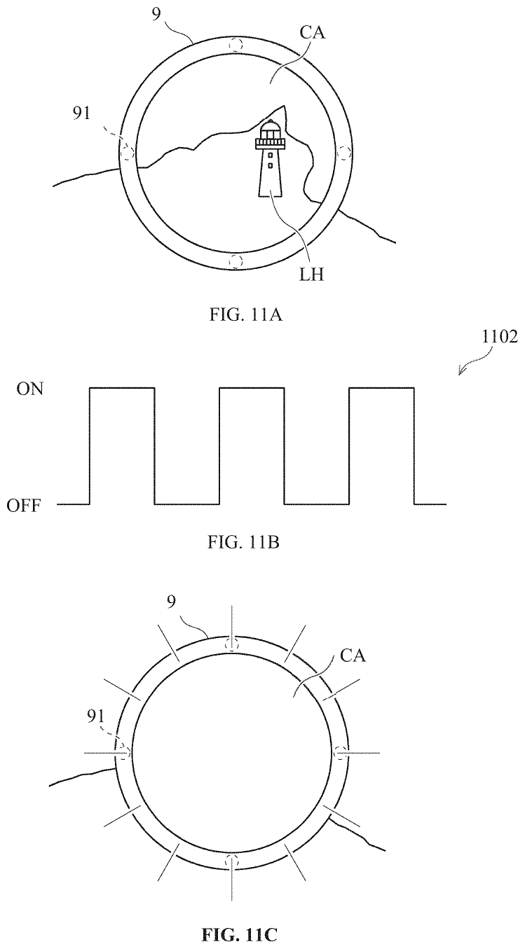

FIGS. 11A, 11B and 11C illustrate an operation for blinking the corresponding area CA in the chart NC, in accordance with another embodiment. The operation may be an operation for flashing the corresponding area CA with a same flashing pattern as a lighthouse included in the corresponding area CA. As shown in FIG. 11A, when a symbol LH of the lighthouse is included in the corresponding area CA determined by the operation auxiliary tool 9, the processing circuitry 10 flashes the corresponding area CA with the flashing pattern based on data of the flashing pattern of the lighthouse. Further, FIG. 11B illustrates an example flashing or blinking pattern of the lighthouse. Moreover, FIG. 11C illustrates blinking or flashing of the corresponding area CA. In particular, the processing circuitry 10 flashes or cause blinking of the corresponding area CA, based on the flashing pattern.

According to the embodiment described above, it is easy to confirm necessary information about a part where the operation auxiliary tool 9 is placed without changing the whole display of the chart NC. Thus, even when the display 6 is surrounded by a plurality of persons, it is possible to confirm a place and information that each person wants to see, and it is possible to improve the efficiency and accuracy of planning a navigation plan.

Although the embodiments of the present disclosure have been described above, the present disclosure is not limited to the embodiments described above, and it is of course possible for those skilled in the art to make various modifications.

### DESCRIPTION OF CODES

(1) Chart display device,
(10) Processing circuitry,
(11) Display control module,
(12) Operation auxiliary tool determination module,
(13) Area identification module,
(14) Operation reception module,
(2) Radar,
(3) GNSS receiver,
(4) Gyrocompass,
(5) AIS,
(6) Display,
(61) Screen
(7) Touch position detection module,
(81) Basic information of own ship,
(82) Menu button,
(83) Orientation adjustment button,
(85) Own ship symbol,
(86) Waypoint,
(87) Route,
(9) Operation auxiliary tool,
(91) Detected element,
(100) Ship ICT system,
(NC) Chart,
(CA) Corresponding area

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A chart display device, comprising:
a display configured to:
display a chart on a screen; and
detect a touched position of the screen; and
processing circuitry configured to:
determine whether an operation auxiliary tool having detected elements is placed on the screen, the detected elements being detected based on the touched position on the screen;
specify a corresponding area corresponding to the operation auxiliary tool in the chart, based on a position of the detected elements of the operation auxiliary tool placed on the screen; and
receive an operation for the corresponding area in the chart.

2. The chart display device of claim 1, wherein the processing circuitry is further configured to:
receive an operation associated with a predetermined pattern when a change pattern of the position of the detected elements coincides with the predetermined pattern.

3. The chart display device of claim 2, wherein
the change pattern is inputted when the operation auxiliary tool placed on the screen is rotated or translated.

4. The chart display device of claim 1, wherein the processing circuitry is further configured to:
receive the operation associated with the predetermined pattern when the change pattern of the touched position detected together with the detected elements coincides with the predetermined pattern.

5. The chart display device of claim 4, wherein,
the change pattern is inputted when a locus is drawn by a touch other than the detected elements while the operation auxiliary tool is placed on the screen.

6. The chart display device of claim 1, wherein,
the operation is an operation for changing the corresponding area.

7. The chart display device of claim 1, wherein,
the operation is an operation to enlarge or reduce the corresponding area.

8. The chart display device of claim 1, wherein,
the operation is an operation for changing a direction of the corresponding area.

9. The chart display device of claim 1, wherein,
the operation is an operation for moving a copy of the corresponding area to another position in the chart in accordance with the movement of the operation auxiliary tool.

10. The chart display device of claim 1, wherein,
the operation is an operation to replace the corresponding area with another image.

11. The chart display device of claim 1, wherein,
the operation is an operation for displaying information associated with the corresponding area.

12. The chart display device of claim 1, wherein
the operation is an operation for blinking the corresponding area in a same blinking pattern as a lighthouse included in the corresponding area.

13. A chart display method for a chart display device, the chart display device having a display configured to display a chart on a screen, and detect a touched position of the screen, the chart display method comprising:
determining whether an operation auxiliary tool having detected elements is placed on the screen, the detected elements being detected based on the touched position on the screen;
specifying a corresponding area corresponding to the operation auxiliary tool in the chart based on the position of the detected elements of the operation auxiliary tool placed on the screen; and
receiving an operation on the corresponding area in the chart.

14. The chart display method of claim 13, further comprising:
receiving an operation associated with a predetermined pattern when a change pattern of the position of the detected elements coincides with the predetermined pattern.

15. An operation auxiliary tool used in a chart display device having a display configured to:
display a chart on a screen; and
detect a touched position of the screen, the operation auxiliary tool comprising;
detected elements configured to be detected, the detected elements being detected by the display; and
inputting an operation for a corresponding area in the chart corresponding to the operation auxiliary tool specified based on the position of the detected elements of the operation auxiliary tool placed on the screen.
